(19) United States
(12) Patent Application Publication
(10) Pub. No.: US 2003/0056008 A1
(43) Pub. Date: Mar. 20, 2003

(54) Automatic remote assignment of internet protocol address information to a network device

(76) Inventors: Richard Francis Russell, Lexington, KY (US); Thomas Elmer Samples, Lexington, KY (US); Brent Allen Schanding, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/957,014

(22) Filed: Sep. 20, 2001

(51) Int. Cl. G06F 15/16

(52) U.S. Cl. 709/245

(57) ABSTRACT

A method of automatically assigning an internet protocol address to a device is provided. The method includes the steps of providing a network; providing a computer communicatively coupled to the network; providing a network adapter to communicatively couple the device to the network; the computer performing the steps of generating an internet protocol address; incorporating the internet protocol address in an address resolution protocol probe; sending the address resolution protocol probe on the network; and determining whether a response to the address resolution protocol probe indicates that the internet protocol address is in use; wherein if the internet protocol address is not in use, then performing the step of assigning the internet protocol address to the network adapter.

### BACKGROUND OF THE INVENTION

1. Field of the Invention

The present invention relates to assignment of internet protocol addresses and, more particularly, to automatically assigning internet protocol address information to a network device, such as a low-cost network adapter.

2. Description of the Related Art

With the large number of network devices, such as printers, which can be connected to a computer network, various methods have been developed to identify and manage network devices enabling them to communicate. Typically, a network directory service, which is essentially a catalog or directory of names and addresses of network devices, is maintained on selected network devices. Devices within a local area network (LAN) usually have their own route tables of other devices in the LAN to allow quick and efficient communication within the LAN.

Each device that receives, sends and/or routes information between or among other devices on a LAN is initialized to communicate with other devices using a communication protocol that may be understood by the other devices. One such communication protocol used by these devices is a transmission control protocol/internet protocol (TCP/IP). Each device that can send or receive information (e.g., a host device) must also have a unique host address. The type of host address used on a LAN that uses TCP/IP, is commonly referred to as an internet protocol (IP) address. A standard TCP/IP address is 4 bytes (32 bits) in length, providing a total of 2³² possible IP addresses. Those of ordinary skill in the art will readily recognize that not all of these possible IP addresses are available due to administrative expediencies, such as reserving blocks of IP addresses for future use.

IP addresses may be dynamically allocated by having a pool of IP addresses, such as an IP address pool, from which to draw each time an IP address is needed. Once a device connects to a network and is properly authenticated, an IP address is allocated for use by the device. This task is normally performed by a Dynamic Host Configuration Protocol (DHCP) server existing on the LAN.

There are several industry standards by which a network device can automatically obtain an IP address information. Such standards include the aforementioned DHCP, Universal Plug and Play (UPnp) and other forms of Automatic Private IP Addressing (APIPA). Each of these standards require that significant network transactions be initiated and conducted by the network device itself which requires hardware and configuration storage, making them cost prohibitive for low-cost devices.

What is needed in the art is an apparatus and a method by which a device on a computer network can be assigned an IP address automatically, without the overhead of supporting traditional address assignment protocols.

### SUMMARY OF THE INVENTION

The present invention provides an apparatus and a method by which a device on a computer network can be assigned an IP address automatically, without the overhead of supporting the traditional address assignment protocols, such as DHCP, within the devices themselves.

The invention comprises, in one form thereof, a method of automatically assigning an internet protocol address to a device. The method includes the steps of providing a network; providing a computer communicatively coupled to the network; providing a network adapter to communicatively couple the device to the network; the computer performing the steps of generating an internet protocol address; incorporating the internet protocol address in an address resolution protocol probe; sending the address resolution protocol probe on the network; and determining whether a response to the address resolution protocol probe indicates that the internet protocol address is in use; wherein if the internet protocol address is not in use, then performing the step of assigning the internet protocol address to the network adapter.

An advantage of the present invention is that it leads to a reduction in the network adapter hardware and firmware requirements, and thus to cost savings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic block diagram of a computer and a device containing a low-cost network adapter in a networked environment embodying the present invention; and

FIG. 2 shows a flow diagram of a process for automatically assigning internet protocol address information to the low-cost network adapter of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

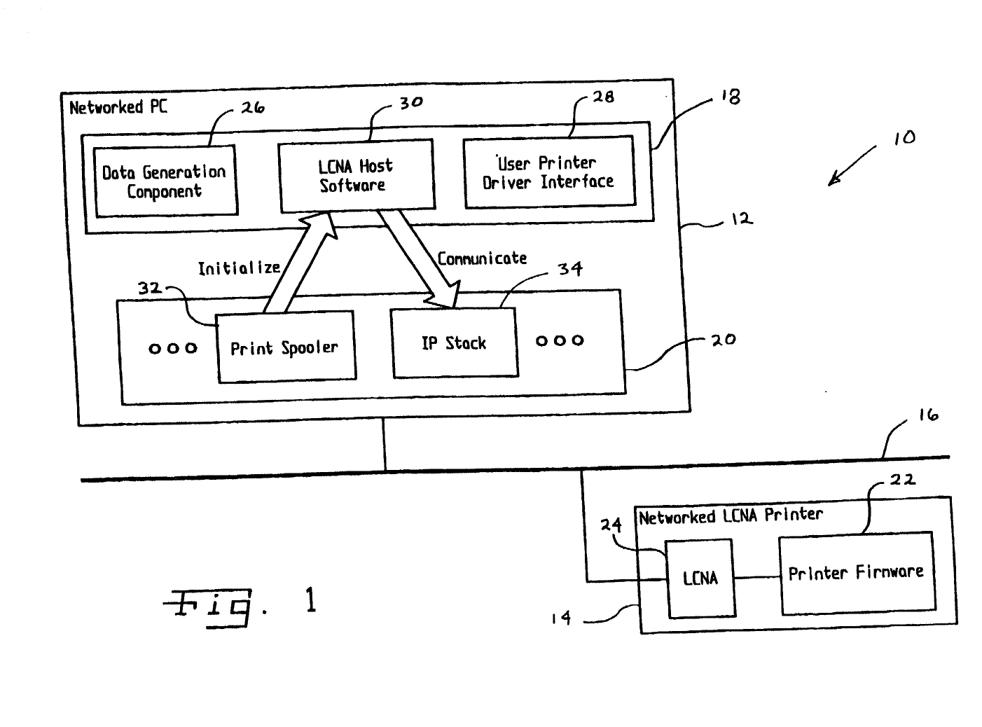

Referring now to the drawings and particularly to FIG. 1, there is shown networked imaging system 10 that includes a computer 12, a networked device 14 and a network 16.

Computer 12 includes software identified as a printer driver 18 and an operating system 20. Printer driver 18 and operating system 20 are communicatively interconnected.

Networked device 14 may be an imaging device, such as a printer. In the embodiment of the invention described herein, networked device 14 will be in the form of a printer. Networked device 14 includes printer firmware 22 and a low-cost network adapter (LCNA) 24, which are communicatively interconnected. All network traffic directed to networked device 14 flows through LCNA 24 to printer firmware 22. Printer firmware 22 is responsible for generating a printed page on networked device 14, and printer firmware 22 relies on LCNA 24 to deliver printer control information and print data thereto.

Network 16, such as a LAN, provides communicative interconnection between computer 12 and networked device 14 and other devices connected thereto which may or may not contain LCNAs. Network 16 is not connected to the internet; however, those skilled in the art will recognize that computer 12 may be adapted for internet connection.

Printer driver 18 includes a data generation component 26, a printer driver user interface 28 and low-cost network adapter (LCNA) host software 30. Printer driver 18 contains the algorithms for assigning IP addresses, and more particularly, for automatically assigning an IP address to LCNA 24. Data generation component 26 generates data to be sent to networked device 14.

Printer driver user interface 28 is software which allows a user to display information relative to the LCNA devices, which are on network 16, and to manually assign IP addresses to devices connected to network 16 where automatic address assignment is not feasible.

LCNA host software 30 contains initialization algorithms for the initialization of LCNA 24. LCNA host software 30 performs the discovery and configuration operations of the present invention.

In the discovery process, LCNA host software 30 obtains a list of LCNA equipped devices on network 16. Associated with the list of LCNA equipped devices is the machine address code (MAC) for each LCNA, which is unique to each LCNA 24. The MAC assigned to LCNA 24 allows LCNA host software 30 to address and communicate with LCNA 24. Also associated with the list of LCNA equipped devices is an IP address assigned to LCNA 24, which can either be a default value or an IP address. A default value associated with an IP address of LCNA 24 is recognized by LCNA host software 30 as an uninitialized LCNA 24.

Operating system 20 includes a print spooler 32 and an IP stack 34. Print spooler 32 is responsible for loading and initializing LCNA host software 30. IP stack 34 is used by LCNA host software 30 to communicate with each LCNA 24 on network 16.

LCNA host software 30 communicates with IP stack 34 to obtain the IP address for networked device 14. If no IP address is available for networked device 14, then LCNA host software 30 is responsible for discovering LCNA 24 equipped devices on network 16. LCNA host software 30 configures LCNA 24 equipped devices, when appropriate, and provides a print connection over which data can be sent to networked device 14 through LCNA 24.

LCNA 24 does not contain a mechanism for obtaining an IP address. Therefore, LCNA 24 depends on the operation of LCNA host software 30 on computer 12 to provide IP information thereto. LCNA 24 may be implemented as an application specific integrated circuit (ASIC).

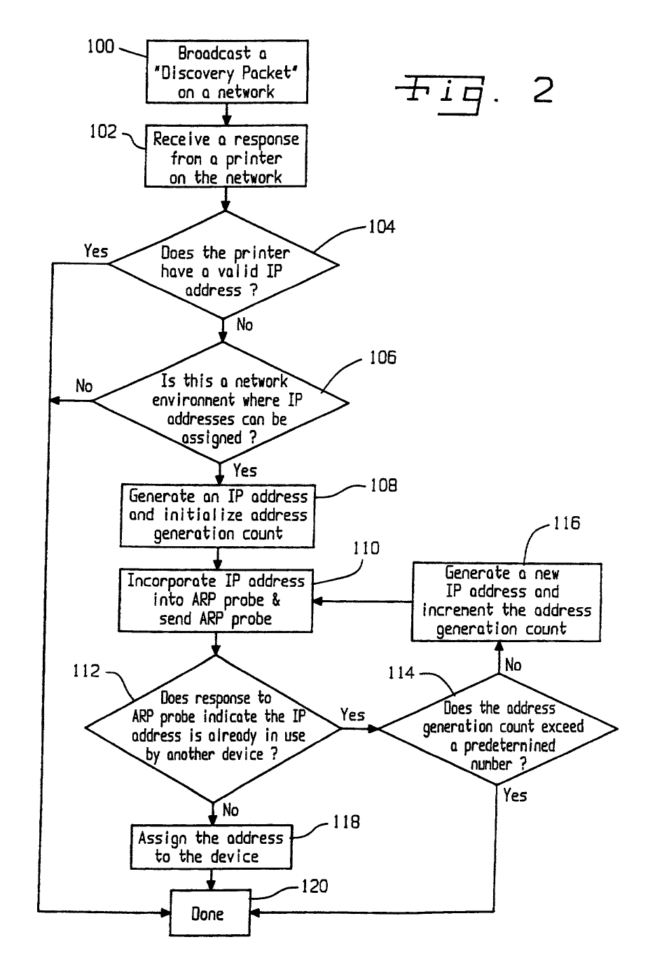

Now additionally referring to FIG. 2, there is depicted a plurality of processing steps, typically executed by an interaction between a computer and an LCNA equipped device on a network, as more fully described below. The process of FIG. 2 may be effected by printer driver software that accompanies a printer that utilizes LCNA 24 or may be software or firmware that is separately loaded on computer 12.

The process of FIG. 2 may be initiated by any of several operations. For example, the process of FIG. 2 may be initiated as the Windows operating system (OS) on computer 12 loads and initializes the print subsystem, print spooler 32 loads and initializes LCNA host software 30. The process of FIG. 2 is then executed as a result of the initialization of LCNA host software 30. Alternatively, in the event a user indicates, through a print spooler graphical user interface, that a device containing LCNA 24 is to be added to network 16, then print spooler 32 notifies LCNA host software 30 to execute the process of FIG. 2. As another alternative, as a precursor to displaying information, in response to a user inquiry, printer driver user interface 28 prompts LCNA host software 30 to perform the process depicted in FIG. 2.

At the point of beginning of the process, and specifically at step 100, computer 12 broadcasts a discovery packet on network 16. A discovery packet is a specific packet of data to which any uninitialized LCNA based network device will respond. LCNA 24 receives the broadcast discovery packet and LCNA 24 responds to the broadcast discovery packet by providing a response, containing information, to computer 12. At step 102, computer 12 receives a response from LCNA 24.

If LCNA 24 has not been provided an IP address, then LCNA 24 is considered to be uninitialized. Until LCNA 24 is initialized, LCNA 24 will not respond to any packets addressed to a specific IP address, nor will LCNA 24 respond to broadcast packets of a general nature, but LCNA 24 is programmed to respond to broadcast packets of a specific nature, such as the broadcast discovery packet sent by computer 12.

At step 104, computer 12 evaluates the response from LCNA 24 to determine if LCNA 24 has a valid IP address. An IP address is considered valid if it is an appropriate address for the subnet to which computer 12 is connected. An uninitialized LCNA always has an invalid IP address. The determination of validity is accomplished by comparing the value associated with the IP address of LCNA 24 to the IP address of computer 12 and a subnet mask of computer 12. If the IP address is valid, then the process terminates at step 120. Otherwise, the process flow continues at step 106.

At step 106, computer 12 determines if network 16 allows automatic remote assignment of IP addresses. If network 16 allows automatic remote assignment of IP addresses, then process flow continues at step 108. Otherwise, the process terminates at step 120. Computer 12 provides for the manual assignment of an IP address, which is not a part of this invention, thus in the event network 16 does not allow automatic remote assignment of IP addresses, an IP address can be assigned manually.

Determination as to whether network 16 allows the assignment of IP addresses to LCNA type devices is necessary since some network environments do not allow for automatic remote IP address assignment. If the network environment utilizes certain addresses, such as those used by the UPnP or APIPA addressing schemes, then automatic remote IP address assignment is possible.

At step 108, computer 12 generates an IP address and initializes an address generation count. The generated IP address is incorporated into an address resolution protocol (ARP) probe. The ARP probe is a network packet to which a device on network 16 will respond if it is using the generated IP address. At step 110, the ARP probe is broadcast on network 16 in order to determine if the generated IP address is in use by any device on network 16. At step 112, computer 12 utilizes the response to the ARP probe to determine whether a device on network 16 has indicated that it is using the generated IP address. If the generated IP address is not in use by any device on network 16, then process flow continues at step 118. Otherwise, the process flow continues at step 114.

The generation of an IP address may be of at least one of random, pseudo-random or sequential in nature. The range of IP addresses that are generated may be constrained to particular ranges if there is a determination that a particular network environment is in use. For example, in the APIPA environment the IP addresses are constrained to be within the range of 192.168.000.000 to 192.168.255.255 and in the UPnP environment the IP addresses are constrained to be within the range of 169.254.000.000 to 169.254.255.255.

In the APIPA environment, IP addresses are based on the first three octets of the IP address which computer 12 is utilizing. For example, if the IP address of computer 12 is 192.168.10.112, then 192.168.10.* is the base address, and the process may, for example, select the *.*.*.200 address as a starting point.

At step 114, the number of times an IP address is generated at step 108 is counted. Computer 12 compares the value of the address generation count to a predetermined number. The predetermined number is a number which will permit several attempts, preferably 20 or more, to automatically assign an IP address to LCNA 24. Although the predetermined number can be any number, in a preferred embodiment, a predetermined number of 30 is used for UPNP environments and a predetermined number of 50 is used for APIPA environments. If the predetermined number is not exceeded by the address generation count, then the process flow continues at step 116. However, if the value of the address generation count does exceed the predetermined number, then the attempt to configure LCNA 24 is abandoned and the process flow then continues at step 120, where it terminates.

At step 116, computer 12 generates a new IP address and increments the address generation count to reflect the additional generation of an IP address. Process flow then continues at step 110.

While in the process described herein the address generation count is initialized, the address generation count is incremented and the address generation count is compared to see if it exceeds a predetermined number, those skilled in the art will recognize that this is only one of several possible conventions which can be used to accomplish this counting. For example, in another convention a count can be initialized to the predetermined number and the count decremented until it is equal to zero.

At step 118, the generated IP address is assigned to LCNA 24. LCNA 24 receives the IP address assignment information in a configuration packet from computer 12, which is directed to the MAC of LCNA 24. LCNA 24 receives the configuration packet, accepts the assignment of the IP address contained therein and puts itself on the network at the assigned IP address. The automatic assignment of an IP address to LCNA 24 is complete, and then the process continues to step 120 where the assignment process is ended.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of automatically assigning an internet protocol address to a device, comprising the steps of:
providing a network;
providing a computer communicatively coupled to said network;
providing a network adapter to communicatively couple said device to said network;
said computer performing the steps of:
generating an internet protocol address;
incorporating said internet protocol address in an address resolution protocol probe;
sending said address resolution protocol probe on said network; and
determining whether a response to said address resolution protocol probe indicates that said internet protocol address is in use;
wherein if said internet protocol address is not in use, then performing the step of assigning said internet protocol address to said network adapter.

2. The method of claim 1, wherein if said internet protocol address is in use, then further comprising the step of repeating said generating step, said incorporating step, said sending step and said determining step.

3. The method of claim 2, further comprising the step of counting a number of times said generating step is performed.

4. The method of claim 3, comprising the step of comparing said number of times said generating step is performed to a predetermined number.

5. The method of claim 4, wherein said predetermined number is at least 30.

6. The method of claim 4, wherein if said number of times said generating step is performed exceeds said predetermined number then said computer does not automatically assign said network adapter an internet protocol address.

7. The method of claim 1, wherein prior to performing said generating step, said method comprising the steps of:
broadcasting a discovery packet on said network;
receiving a response from said network adapter; and
determining if said network adapter has a valid internet protocol address.

8. The method of claim 7, wherein prior to performing said generating step said method comprising the step of determining whether said network allows said computer to assign an internet protocol address to said network adapter.

9. The method of claim 1, wherein said device is a printer.

10. The method of claim 1, wherein said network adapter is a low-cost network adapter.

11. A method of automatically assigning an internet protocol address to a device, comprising the steps of:
providing a network;
providing a computer communicatively coupled to said network;
providing a low-cost network adapter to communicatively couple said device to said network;
said computer performing the steps of:
broadcasting a discovery packet on said network;
receiving a response from said low-cost network adapter;
determining if said low-cost network adapter has a valid internet protocol address;
wherein if said low-cost network adapter does not have a valid internet protocol address, then said computer performing the steps of:
generating an internet protocol address;
incorporating said internet protocol address in an address resolution protocol probe;
sending said address resolution protocol probe on said network; and
determining whether a response to said address resolution protocol probe indicates that said internet protocol address is in use;
wherein if said internet protocol address is not in use, then performing the step of assigning said internet protocol address to said low-cost network adapter.

12. The method of claim 11, wherein if said internet protocol address is in use, then further comprising the step of repeating said generating step, said incorporating step, said sending step and said determining step.

13. The method of claim 12, further comprising the step of counting a number of times said generating step is performed.

14. The method of claim 13, comprising the step of comparing said number of times said generating step is performed to a predetermined number.

15. The method of claim 14, wherein said predetermined number is at least 30.

16. The method of claim 14, wherein if said number of times said generating step is performed exceeds said predetermined number then said computer does not automatically assign said low-cost network adapter an internet protocol address.

17. A network based imaging system, comprising:
a network;
a computer communicatively coupled to said network;
an imaging device; and
a network adapter communicatively coupling said imaging device to said network;
wherein said computer executes instructions which generate an internet protocol address, incorporate said internet protocol address into an address resolution protocol probe, send said address resolution protocol probe on said network, utilize a response to said address resolution protocol probe to determine if said internet protocol address is in use and if said internet protocol address is not in use, then assign said internet protocol address to said network adapter.

18. The system of claim 17, wherein if said internet protocol address is in use then said computer repeats said instructions.

19. The system of claim 18, wherein said computer counts a number of times said instructions are executed.

20. The system of claim 19, wherein said computer compares said number of times said instructions are executed to a predetermined number.

21. The system of claim 20, wherein said predetermined number is at least 30.

22. The system of claim 20, wherein if said number of times said instructions are executed exceeds said predetermined number then said computer does not automatically assign said network adapter an internet protocol address.

23. The system of claim 17, wherein prior to performing said instructions said computer executes preliminary instructions which broadcast a discovery packet on said network, receive a response from said network adapter and determine if said network adapter has a valid internet protocol address.

24. The system of claim 23, wherein said preliminary instructions further determine whether said network allows said computer to assign an internet protocol address to said network adapter.

25. The system of claim 17, wherein said network adapter is a low-cost network adapter.
